(19) United States
(12) Patent Application Publication
(10) Pub. No.: US 2024/0215102 A1
(43) Pub. Date: Jun. 27, 2024

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/544,469

(22) Filed: Dec. 19, 2023

(30) Foreign Application Priority Data
Dec. 26, 2022 (CN) 202211673621.7

(51) Int. Cl. H04W 76/27; H04W 52/02

(52) U.S. Cl. CPC H04W 76/27; H04W 52/0225

(57) ABSTRACT

The present application discloses a method and device for wireless communications, comprising receiving a first signaling, the first signaling being used to configure a value of a first timer; transmitting a first signal; accompanying the first signal, starting the first timer; herein, the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state. The present application can better save power through an indication of a first signaling and a first signal.

### CROSS REFERENCE TO RELATED APPLICATIONS

This application claims the priority benefit of Chinese Patent Application No.202211673621.7, filed on Dec. 26, 2022, the full disclosure of which is incorporated herein by reference.

### BACKGROUND

### Technical Field

The present application relates to transmission methods and devices in wireless communication systems, to RRC connection establishment and maintenance, to wireless resource management, and in particular to power saving.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72 plenary decided to conduct the study of New Radio (NR), or what is called fifth Generation (5G). The work Item (WI) of NR was approved at 3GPP RAN #75 plenary to standardize the NR.

In communications, whether Long Term Evolution (LTE) or 5G NR involves features of accurate reception of reliable information, optimized energy efficiency ratio, determination of information efficiency, flexible resource allocation, scalable system structure, efficient non-access layer information processing, low service interruption and dropping rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various service, improving spectrum utilization and improving service quality, which are indispensable in enhanced Mobile BroadBand (eMBB), Ultra Reliable Low Latency Communications (URLLC) and enhanced Machine Type Communications (eMTC). Meanwhile, in the following communication modes, covering Industrial Internet of Things (IIoT), Vehicular to X (V2X), Device to Device communications , Unlicensed Spectrum communications, User communication quality monitoring, network planning optimization, Non-Territorial Networks (NTN), Territorial Networks (TN), and Dual connectivity system, there are extensive requirements in radio resource management and selection of multi-antenna codebooks as well as in signaling design, adjacent cell management, service management and beamforming. Transmission methods of information are divided into broadcast transmission and unicast transmission, both of which are essential for 5G system for that they are very helpful to meet the above requirements. The UE can be connected to the network directly or through a relay.

With the increase of scenarios and complexity of systems, higher requirements are raised for interruption rate and time delay reduction, reliability and system stability enhancement, service flexibility and power saving. At the same time, compatibility between different versions of different systems should be considered when designing the systems.

3GPP standardization organization has done relevant standardization work for 5G and formed a series of standards. The standard contents can be referred to:

https://www.3gpp.org/ftp/Specs/archive/38_series/38.213/38213-h00.zip

https://www.3gpp.org/ftp/Specs/archive/38_series/38.331/38331-h00.zip

https://www.3gpp.org/ftp/Specs/archive/38_series/38.304/38304-h00.zip

### SUMMARY

In the latest 3GPP research topics, the issue of power saving is involved, especially the power saving at the base station side is involved. In order to reduce transmit power, the base station may shut down or alter transmission of partial signals, which may have an impact on UE communications. For example, an old version of UE cannot end the system, while a new version of UE may require a longer time to access the system. In traditional NR systems, UE generally does not wait or try permanently during connection establishment, including connection resume or modification, as that may result in the UE to be out of service for a long time, therefore, some timers are used to control it. When the timer expires and the establishment or modification of the connection still cannot be completed, it is treated as a failure, e.g. entering RRC_IDLE state. The UE can follow up by, for example, re-selecting another cell for the access attempt, so that failure, if it occurs, does not have a particularly serious impact. But how to set these timers becomes a problem. The delay for establishing or modifying an RRC connection relies on cell broadcast information. In traditional systems, the network condition is relatively homogeneous and transmission of the broadcast information is in a fixed manner, since the UE has to measure the broadcast information several times to get the quality of the cell, and then get the key broadcast information, e.g., the broadcast information comprising the system parameters, before accessing the system, so the estimation of the total delay and the setting of the timer are easier. However, for power-saving base stations, the transmission of broadcast information is variable, and sometimes the transmitted broadcast information may not be able to satisfy the access demand, the transmission period of the broadcast information may be long, or the transmission period of the broadcast information may change at any time according to different situations, so the delay of establishing and modifying the RRC connection is difficult to be predicted. In conclusion, simply following the traditional way of starting the timer, i.e., without taking into account the transmission of broadcast information, is not able to meet the requirements of a complex and changing network situation. Therefore, one issue to be addressed is how to configure the timer in a way that can accommodate a cell using power-saving techniques.

To address the above problem, the present application provides a solution.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict. At the same time, the method proposed in the present application can also be used to solve other problems in communications.

The present application provides a method in a first node for wireless communications, comprising:
receiving a first signaling, the first signaling being used to configure a value of a first timer; and
transmitting a first signal; accompanying the first signal, starting the first timer;
herein, the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state.

In one embodiment, a problem to be solved in the present application comprises: how to properly establish a connection with cells that use power-saving techniques; how to adaptively determine a value of a timer based on broadcast information of a cell; how to connect to cells transmitting different broadcast information; how to configure a timer used for an RRC connection.

In one embodiment, advantages of the above method comprise: saving power to the base station and having good flexibility; being conducive to ensuring service continuity, preventing communication interruptions or reducing interruption time; ensuring QoS.

Specifically, according to one aspect of the present application, an expiration of the first timer is used to trigger connection failure.

Specifically, according to one aspect of the present application, transmit a second signal, and the second signal is used to wake up the first cell;
herein, the second signal is a physical-layer signal; after the first cell is waken up, the first cell enters the first state; the meaning of the phrase of compared to the first cell in first state, when the first cell is in second state, a start of the first timer being later comprises: when the first cell is in the second state, the first timer starts after the first cell is waken up.

Specifically, according to one aspect of the present application, the meaning of the phrase of the first signal being used for an RRC connection is: the first signal is used to request an establishment of an RRC connection or to request a resume of an RRC connection; the first signal comprises an RRC message; a stopping condition of the first timer comprises: receiving a response to the first signal; the meaning of the phrase of accompanying the first signal, starting the first timer comprises: when the first cell is in the first state and when the first signal is transmitted, the first timer is started; when the first cell is in the second state and when the first signal is transmitted and the first cell is waken up, the first timer is started.

Specifically, according to one aspect of the present application, receive a first message; the first message comprises a reconfiguration of RRC;
herein, the meaning of the phrase of the first signal being used for an RRC connection is: the first signal is used to modify an RRC connection, and the first signal is used to indicate that a reconfiguration of RRC is completed; a stopping condition of the first timer comprises: a random access process for the first cell is successfully completed; the meaning of the phrase of accompanying the first signal, starting the first timer comprises: when the first cell is in the first state and when the first message is received, the first timer is started; when the first cell is in the second state and when the first message is received and the first cell is waken up, the first timer is started; a successful application of the first message triggers a transmission of the first signal.

Specifically, according to one aspect of the present application, receive a first message; the first message comprises a conditional reconfiguration of RRC; store the first message; as a response to a condition associated with a conditional reconfiguration of the RRC comprised in the first message being satisfied, execute the stored the first message;
herein, the meaning of the phrase of the first signal being used for an RRC connection is: the first signal is used to modify an RRC connection, and the first signal is used to indicate that a reconfiguration of RRC is completed; a stopping condition of the first timer comprises: a random access process for the first cell is successfully completed; the meaning of the phrase of accompanying the first signal, starting the first timer comprises: when the first cell is in the first state and when the stored first message is applied, the first timer is started; when the first cell is in the second state and when the stored first message is applied and the first cell is waken up, the first timer is started; a successful application of the first message triggers a transmission of the first signal.

Specifically, according to one aspect of the present application, transmit a first random access signal;
herein, candidate resources used for transmitting the first random access signal are related to whether the first cell is in the first state or the second state.

Specifically, according to one aspect of the present application, transmit a third signal, and the third signal is used to request system information; accompanying a transmission of the third signal, start a second timer;
herein, the third signal is only transmitted when the second timer is not running; the behavior of starting a second timer comprises setting a value of the second timer, and a start of the second timer is related to whether the first cell is in the first state or the second state.

Specifically, according to one aspect of the present application, the first node is an IoT terminal.

Specifically, according to one aspect of the present application, the first node is a UE.

Specifically, according to one aspect of the present application, the first node is a relay.

Specifically, according to one aspect of the present application, the first node is an access network device.

Specifically, according to one aspect of the present application, the first node is a vehicle terminal.

Specifically, according to one aspect of the present application, the first node is an aircraft.

Specifically, according to one aspect of the present application, the first node is a mobile phone.

The present application provides a method in a second node for wireless communications, comprising:
transmitting a first signaling, the first signaling being used to configure a value of a first timer; and
receiving a first signal;
herein, the first timer is started accompanying the first signal; the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state.

Specifically, according to one aspect of the present application, an expiration of the first timer is used to trigger connection failure.

Specifically, according to one aspect of the present application, receive a second signal, and the second signal is used to wake up the first cell;
herein, the second signal is a physical-layer signal; after the first cell is waken up, the first cell enters the first state; the meaning of the phrase of compared to the first cell in first state, when the first cell is in second state, a start of the first timer being later comprises: when the first cell is in the second state, the first timer starts after the first cell is waken up.

Specifically, according to one aspect of the present application, the meaning of the phrase of the first signal being used for an RRC connection is: the first signal is used to request an establishment of an RRC connection or to request a resume of an RRC connection; the first signal comprises an RRC message; a stopping condition of the first timer comprises: receiving a response to the first signal; the meaning of the phrase of accompanying the first signal, starting the first timer comprises: when the first cell is in the first state and when the first signal is transmitted, the first timer is started; when the first cell is in the second state and when the first signal is transmitted and the first cell is waken up, the first timer is started.

Specifically, according to one aspect of the present application, transmit a first message; the first message comprises a reconfiguration of RRC;
herein, the meaning of the phrase of the first signal being used for an RRC connection is: the first signal is used to modify an RRC connection, and the first signal is used to indicate that a reconfiguration of RRC is completed; a stopping condition of the first timer comprises: a random access process for the first cell is successfully completed; the meaning of the phrase of accompanying the first signal, starting the first timer comprises: when the first cell is in the first state and when the first message is received, the first timer is started; when the first cell is in the second state and when the first message is received and the first cell is waken up, the first timer is started; a successful application of the first message triggers a transmission of the first signal.

Specifically, according to one aspect of the present application, transmit a first message; the first message comprises a conditional reconfiguration of RRC; store the first message; as a response to a condition associated with a conditional reconfiguration of the RRC comprised in the first message being satisfied, execute the stored the first message;
herein, the meaning of the phrase of the first signal being used for an RRC connection is: the first signal is used to modify an RRC connection, and the first signal is used to indicate that a reconfiguration of RRC is completed; a stopping condition of the first timer comprises: a random access process for the first cell is successfully completed; the meaning of the phrase of accompanying the first signal, starting the first timer comprises: when the first cell is in the first state and when the stored first message is applied, the first timer is started; when the first cell is in the second state and when the stored first message is applied and the first cell is waken up, the first timer is started; a successful application of the first message triggers a transmission of the first signal.

Specifically, according to one aspect of the present application, receive a first random access signal;
herein, candidate resources used for transmitting the first random access signal are related to whether the first cell is in the first state or the second state.

Specifically, according to one aspect of the present application, receive a third signal, and the third signal is used to request system information; accompanying a transmission of the third signal, start a second timer;
herein, the third signal is only transmitted when the second timer is not running; the behavior of starting a second timer comprises setting a value of the second timer, and a start of the second timer is related to whether the first cell is in the first state or the second state.

Specifically, according to one aspect of the present application, the second node is a network device.

Specifically, according to one aspect of the present application, the second node is a base station.

Specifically, according to one aspect of the present application, the second node is a relay.

Specifically, according to one aspect of the present application, the second node is an access point.

Specifically, according to one aspect of the present application, the second node is an aircraft.

Specifically, according to one aspect of the present application, the second node is a satellite.

The present application provides a first node for wireless communications, comprising:
a first receiver, receiving a first signaling, the first signaling being used to configure a value of a first timer; and
a first transmitter, transmitting a first signal; accompanying the first signal, starting the first timer;
herein, the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state.

The present application provides a second node for wireless communications, comprising:
a second transmitter, transmitting a first signaling, the first signaling being used to configure a value of a first timer; and
a second receiver, receiving a first signal;
herein, the first timer is started accompanying the first signal; the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state.

In one embodiment, the present application has the following advantages over conventional schemes:
being more power saving and more flexible.
supporting different types of cells, and supporting cells that transmit different broadcast information.
it is possible to avoid both wasting too much time on a poor-quality cell and failing to access a suitable cell because the timer expires prematurely.
supporting cells with different power-saving states.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first signaling, transmitting a first radio signal and starting a first timer according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of broadcast information according to one embodiment of the present application;

FIG. 7 illustrates a schematic diagram of broadcast information according to one embodiment of the present application;

FIG. 8 illustrates a schematic diagram of a first signal being used for an RRC connection according to one embodiment of the present application;

FIG. 9 illustrates a schematic diagram of the second signal being used to awake a first cell according to one embodiment of the present application;

FIG. 10 illustrates a schematic diagram of a processor in a first node according to one embodiment of the present application;

FIG. 11 illustrates a schematic diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of receiving a first signaling, transmitting a first radio signal and starting a first timer according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, a first node in the present application receives a first signaling in step 101; transmits a first radio signal in step 102; starts a first timer in step 103;
herein, the first signaling is used to configure a value of a first timer; the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state.

In one embodiment, the first node is a User Equipment (UE).

In one embodiment, the first node is in RRC_CONNECTED state.

In one embodiment, the first node is in RRC_IDLE state.

In one embodiment, the first node is in RRC_INACTIVE state.

In one embodiment, a serving cell refers to a cell where a UE resides; executing a cell search comprises: a UE searches for a suitable cell of a selected Public Land Mobile Network (PLMN) or a Stand-alone Non-Public Network (SNPN), selects the suitable cell to provide available services, and monitors a control channel of the suitable cell, and this procedure is defined as camping on a cell; that is, a camped cell is a serving cell of the UE relative to the UE. Advantages of camping on a cell in RRC_IDLE state or RRC_INACTIVE state: enabling the UE to receive a system message from the PLMN or the SNPN; after registration, if the UE wishes to establish an RRC connection or continue a suspended RRC connection, the UE can achieve this by executing an initial access on a control channel of residing camping cell; the network may page the UE; so that the UE can receive notifications of Earthquake and Tsunami Warning System (ETWS) and Commercial Mobile Alert System (CMAS).

In one embodiment, for a UE in RRC_CONNECTED state that is not configured with carrier aggregation/dual connectivity (CA/DC), only one serving cell comprises a PCell; for a UE in RRC_CONNECTED state that is configured with CA/DC, a serving cell is used to indicate a cell set comprising a Special Cell (SpCell) and all sub-cells. The PCell is a cell in a Master Cell Group (MCG), which works at primary frequency, and the UE executes an initial connection establishment procedure or initiates a connection re-establishment on the PCell. For a dual connectivity operation, an SpCell refers to a PCell of an MCG or a Primary SCG Cell (PSCell) of an SCG; if it is not a dual connectivity operation, an SpCell refers to a PCell.

In one embodiment, a frequency at which a Secondary Cell (SCell) operates is a sub-frequency.

In one embodiment, an individual content of an information element is called a field.

In one embodiment, a Multi-Radio Dual Connectivity (MR-DC) refers to a dual connectivity between an E-UTRA and an NR node, or a dual connectivity between two NR nodes.

In one embodiment, in an MR-DC, a radio access node providing a control-plane connection to the core network is a master node, and the master node may be a master eNB, a master ng-eNB, or a master gNB.

In one embodiment, an MCG refers to, in MR-DC, a group of serving cells associated with a master node, comprising an SpCell, and optionally one or multiple SCells.

In one embodiment, a PCell is an SpCell of an MCG.

In one embodiment, a PSCell is an SpCell of an SCG.

In one embodiment, in an MR-DC, a control plane connection to the core network is not provided, and a radio access node providing extra resources to the UE is a sub-node. The sub-node can be an en-gNB, a sub-ng-eNB or a sub-gNB.

In one embodiment, in an MR-DC, a group of serving cells associated with a sub-node is a Secondary Cell Group (SCG), comprising an SpCell and, optionally, one or multiple SCells.

In one embodiment, the first signaling is not transmitted via sidelink.

In one embodiment, the first signaling is transmitted via sidelink.

In one embodiment, the first signaling is transmitted through a link other than sidelink.

In one embodiment, the first signaling is transmitted through a main link.

In one embodiment, a transmitter of the first signaling is an MCG of the first node.

In one embodiment, a transmitter of the first signaling is a PCell of the first node.

In one embodiment, a generator of the first signaling is a PCell of the first node.

In one embodiment, a transmitter of the first signaling is a serving cell of the first node.

In one embodiment, the first signaling is unicast.

In one embodiment, a C-RNTI of the first node is used for scrambling of the first signaling.

In one embodiment, the first signaling is broadcast.

In one embodiment, the first signaling comprises an RRCReconfiguration message.

In one embodiment, the first signaling comprises an RRCRelease.

In one embodiment, the first signaling is or comprises partial fields in an RRCReconfiguration message.

In one embodiment, the first signaling is or comprises UE-TimersAndConstants.

In one embodiment, the first signaling configures a value of the first timer.

In one embodiment, the first signaling configures an expiration time of the first timer.

In one embodiment, the first signaling configures a starting condition for the first timer.

In one embodiment, a value of the first timer is an expected expiration time of the first timer.

In one embodiment, without intervention, a time determined by a value of the timer after a start of a timer is a time when the timer expires.

In one embodiment, without intervention, a timer expires at a time determined by a value of the timer after the start.

In one embodiment, a name of the first timer comprises T3.

In one embodiment, the first timer comprises T300.

In one embodiment, the first timer comprises T319.

In one embodiment, the first timer comprises T301.

In one embodiment, the first timer comprises T311.

In one embodiment, the first timer comprises T304.

In one embodiment, an expiration of the first timer triggers entering RRC_IDLE state.

In one embodiment, an expiration of the first timer is considered or used to determine a connection failure.

In one embodiment, an expiration of the first timer is considered or used to determine RRC reconfiguration failure.

In one embodiment, an expiration of the first timer is used to trigger failure.

In one embodiment, an expiration of the first timer is considered a failure.

In one embodiment, the old versions refer to 3GPP release 15 and previous NR versions.

In one embodiment, the old versions refer to 3GPP release 16 and previous NR versions.

In one embodiment, the old versions refer to 3GPP release 17 and previous NR versions.

In one embodiment, the old versions refer to NR versions prior to 3GPP release 18.

In one embodiment, the old versions refer to versions prior to 3GPP release NR protocol version supported by the first node.

In one embodiment, an RRC message can simultaneously comprise both legacy RRC signaling field and illegal RRC signaling field.

In one embodiment, the first signal comprises a random access signal.

In one embodiment, the first signal is an RRC message.

In one embodiment, the first signaling is used to indicate resources occupied by the first signal.

In one embodiment, resources occupied by the first signal are associated with reference signal resources of a transmitter of the first signaling.

In one embodiment, resources occupied by the first signal depend on reference signal resources of a transmitter of the first signaling.

In one embodiment, the first signal comprises an RRCSetupRequest message.

In one subembodiment of the above embodiment, the first signal is used for requesting an RRC connection.

In one subembodiment of the above embodiment, the RRC connection is an RRC connection with the first cell.

In one subembodiment of the above embodiment, the RRC connection is for an RRC connection with the first cell.

In one subembodiment of the above embodiment, the RRC connection is an RRC connection with a cell group of the first cell.

In one subembodiment of the above embodiment, the RRC connection is an RRC connection with a radio access network to which the first cell belongs.

In one subembodiment of the above embodiment, the first signal is transmitted using resources of the first cell.

In one subembodiment of the above embodiment, the first signal uses the first cell or a signaling radio bearer of a cell group to which the first cell belongs for a transmission.

In one embodiment, the first signal comprises an RRCResumeRequest message.

In one subembodiment of the above embodiment, the first signal is used for resuming an RRC connection.

In one subembodiment of the above embodiment, the RRC connection is an RRC connection with the first cell.

In one subembodiment of the above embodiment, the RRC connection is for an RRC connection with the first cell.

In one subembodiment of the above embodiment, the RRC connection is an RRC connection with a cell group of the first cell.

In one subembodiment of the above embodiment, the RRC connection is an RRC connection with a radio access network to which the first cell belongs.

In one subembodiment of the above embodiment, the first signal is transmitted by using resources of the first cell.

In one subembodiment of the above embodiment, the first signal uses the first cell or a signaling radio bearer of a cell group to which the first cell belongs for a transmission.

In one embodiment, the first signal comprises an RRCResumeRequest1 message.

In one subembodiment of the above embodiment, the first signal is used for resuming an RRC connection.

In one subembodiment of the above embodiment, the first signal is used for requesting an RRC connection.

In one subembodiment of the above embodiment, the RRC connection is an RRC connection with the first cell.

In one subembodiment of the above embodiment, the RRC connection is an RRC connection for the first cell.

In one subembodiment of the above embodiment, the RRC connection is an RRC connection with a cell group of the first cell.

In one subembodiment of the above embodiment, the RRC connection is an RRC connection with a radio access network to which the first cell belongs.

In one subembodiment of the above embodiment, the first signal is transmitted by using resources of the first cell.

In one subembodiment of the above embodiment, the first signal uses the first cell or a signaling radio bearer of a cell group to which the first cell belongs for a transmission.

In one embodiment, the first signal comprises an RRCReestablishmentRequest message.

In one subembodiment of the above embodiment, the first signal is used for re-establishing an RRC connection.

In one subembodiment of the above embodiment, the RRC connection is an RRC connection with the first cell.

In one subembodiment of the above embodiment, the RRC connection is an RRC connection for the first cell.

In one subembodiment of the above embodiment, the RRC connection is an RRC connection with a cell group of the first cell.

In one subembodiment of the above embodiment, the RRC connection is an RRC connection with a radio access network to which the first cell belongs.

In one subembodiment of the above embodiment, the first signal is transmitted by using resources of the first cell.

In one subembodiment of the above embodiment, the first signal uses the first cell or a signaling radio bearer of a cell group to which the first cell belongs for a transmission.

In one embodiment, the first signal comprises an RRCReconfigurationComplete message.

In one subembodiment of the above embodiment, the first signal is used for modifying an RRC connection.

In one subembodiment of the above embodiment, the first signal is used to confirm a completion of an RRC connection modification.

In one subembodiment of the above embodiment, the RRC connection is an RRC connection with the first cell.

In one subembodiment of the above embodiment, the RRC connection is an RRC connection for the first cell.

In one subembodiment of the above embodiment, the RRC connection is an RRC connection with a cell group of the first cell.

In one subembodiment of the above embodiment, the RRC connection is an RRC connection with a radio access network to which the first cell belongs.

In one subembodiment of the above embodiment, the first signal is transmitted by using resources of the first cell.

In one subembodiment of the above embodiment, the first signal uses the first cell or a signaling radio bearer of a cell group to which the first cell belongs for a transmission.

In one embodiment, the meaning of the phrase of accompanying the first signal, starting the first timer comprises: when the first signal is transmitted, the first timer must be started.

In one embodiment, the meaning of the phrase of accompanying the first signal, starting the first timer comprises: when the first timer must be started, the first signal must be transmitted.

In one embodiment, the meaning of the phrase of accompanying the first signal, starting the first timer comprises: when the first signal is transmitted, the first timer is started.

In one embodiment, the meaning of the phrase of accompanying the first signal, starting the first timer comprises: a condition for the first timer to be started comprises the first signal being transmitted.

In one embodiment, the meaning of the phrase of accompanying the first signal, starting the first timer comprises: the first timer starts before the first signal is transmitted.

In one embodiment, the meaning of the phrase of accompanying the first signal, starting the first timer comprises: the first timer starts before the first signal is transmitted, and when the first timer is stopped, the first signal is transmitted.

In one subembodiment of the above embodiment, the first signal is used to confirm a completion of an RRC connection modification.

In one subembodiment of the embodiment, a condition for the first timer to be stopped is that a random access to the first cell is successfully completed.

In one embodiment, the first cell is a PCell of the first node.

In one embodiment, the first cell is an SPCell of the first node.

In one embodiment, the first cell is a serving cell of the first node.

In one embodiment, the first cell is a cell that supports or utilizes network power savings.

In one embodiment, the first cell does not support: legacy UE.

In one embodiment, the first cell does not support when it is not activated: legacy UE.

In one embodiment, the first cell does not support when it is not waken up: legacy UE.

In one embodiment, the first cell is a target cell of the first node.

In one subembodiment of the embodiment, the target cell is a target cell for handover of the first node.

In one subembodiment of the embodiment, the target cell is a target cell for mobility management of the first node.

In one embodiment, the first timer only has one value.

In one embodiment, the value of the first timer is a longest running time of the first timer.

In one embodiment, the value of the first timer is an expected expiration time of the first timer.

In one embodiment, the value of the first timer is an expiration value of the first timer.

In one embodiment, the first timer expires without intervention at a time determined by the value of the first timer after a start of the first timer.

In one embodiment, when broadcast information of the first cell does not comprise SIB1, a start of the first timer is later than a start of the first timer when broadcast information of the first cell comprises SIB1.

In one subembodiment of the embodiment, the meaning of the phrase of broadcast information of the first cell not comprising SIB1 is: the first cell does not transmit SIB1, or does not transmit SIB1 without a request.

In one subembodiment of the embodiment, the meaning of the phrase of broadcast information of the first cell not comprising SIB1 is: the first cell not only transmits SIB1 upon request.

In one subembodiment of the embodiment, the meaning of the phrase of broadcast information of the first cell comprising SIB1 is: the first cell periodically transmits system information block 1 (SIB1).

In one embodiment, when broadcast information of the first cell does not comprise a synchronization signal block (SSB) interpretable by legacy UE, a start of the first timer is later than a start of the first timer when broadcast information of the first cell comprises an SSB interpretable by legacy UE.

In one subembodiment of the embodiment, the meaning of the phrase of broadcast information of the first cell not comprising an SSB interpretable by legacy UE is: the first cell does not transmit SSB, or does not transmit SSB without a request.

In one subembodiment of the embodiment, the meaning of the phrase of broadcast information of the first cell not comprising SIB1 is: an SSB transmitted by the first cell is a new version of SSB.

In one subembodiment of the embodiment, the meaning of the phrase of broadcast information of the first cell comprising an SSB interpretable by legacy UE is: the first cell periodically transmits an SSB interpretable by legacy UE.

In one embodiment, the meaning that broadcast information of the first cell does not support legacy UE is: broadcast information of the first cell is not compatible with legacy UE.

In one embodiment, the meaning that broadcast information of the first cell does not support legacy UE is:

broadcast information of the first cell indicates baring legacy UE.

In one embodiment, when broadcast information of the first cell does not indicate CORESET #0, a start of the first timer is later than a start of the first timer when broadcast information of the first cell indicates CORESET #0.

In one subembodiment of the embodiment, the CORESET#0 is used to schedule SIB1.

In one subembodiment of the embodiment, the CORESET#0 is interpretable by legacy UE.

In one embodiment, when broadcast information of the first cell does not comprise a first-type signal, a start of the first timer is later than a start of the first timer when broadcast information of the first cell comprises a first-type signal.

In one subembodiment of the embodiment, the meaning of the phrase of broadcast information of the first cell not comprising a first-type signal is: the first cell does not transmit the first-type signal, or the first cell only transmits a first-type signal when requested.

In one subembodiment of the above embodiment, the first-type signal is an SSB.

In one subembodiment of the above embodiment, the first-type signal is a synchronization signal.

In one subembodiment of the above embodiment, the first-type signal is SIB1.

In one subembodiment of the above embodiment, the first-type signal is one or multiple in SIB.

In one subembodiment of the above embodiment, the first-type signal is an MIB.

In one embodiment, when broadcast information of the first cell is not scheduled by a DCI scrambled by a system information-radio network temporary identity (SI-RNTI), a start of the first timer is later than a start of the first timer when broadcast information of the first cell is not scheduled by a DCI scrambled by an SI-RNTI.

In one embodiment, when broadcast information of the first cell is not scheduled by a PDCCH scrambled by an SI-RNTI, a start of the first timer is later than a start of the first timer when broadcast information of the first cell is scheduled by a PDCCH scrambled by an SI-RNTI.

In one embodiment, when broadcast information of the first cell indicates network power-saving, a start of the first timer is later than a start of the first timer when broadcast information of the first cell does not indicate network power saving.

In one embodiment, the broadcast information of the first cell is or comprises a primary synchronization signal (PSS).

In one embodiment, the broadcast information of the first cell is or comprises a secondary synchronization signal (SSS).

In one embodiment, the broadcast information of the first cell is or comprises a master information block (MIB).

In one embodiment, the broadcast information of the first cell is or comprises SIB1.

In one embodiment, the broadcast information of the first cell only comprises a synchronization signal.

In one subembodiment of the embodiment, the synchronization signal is a PSS.

In one subembodiment of the embodiment, the synchronization signal is an SSS.

In one subembodiment of the embodiment, the synchronization signal is a PSS and the synchronization signal is an SSS.

In one subembodiment of the embodiment, the first cell only supports request-based MIB transmission.

In one embodiment, the first signal only comprises an SSB.

In one subembodiment of the embodiment, the first cell only supports request-based SIB1 transmission.

In one embodiment, in a network that supports at least a former of the old version and the 3GPP release version supported by the first node, system Information (SI) is divided into a Master Information Block (MIB), several

System Information Blocks (SIBs), and optional a Positioning SIB (posSIB).

In one embodiment, in a network that supports at least a former of the old version and the 3GPP release version supported by the first node, an MIB is always transmitted on a Broadcast Channel (BCH) with a period of 80 ms and can be repeated within 80 ms, and the MIB comprises parameters used for obtaining SIB1.

In one embodiment, in a network that supports at least a former of the old version and the 3GPP release version supported by the first node, a repetition of an MIB is scheduled based on a period of a synchronization signal block (SSB).

In one embodiment, in a network that supports at least a former of the old version and the 3GPP release version supported by the first node, an MIB and an SIB1 are referred to as a minimum SI, which comprises basic information necessary for an initial access, as well as information required to obtain other SIBs.

In one embodiment, in a network that supports at least a former of the old version and the 3GPP release version supported by the first node, an MIB comprises cell baring status information and essential physical-layer information of the cell.

In one embodiment, in a network that supports at least a former of the old version and the 3GPP release version supported by the first node, SIB1 defines scheduling information of other SIBs and comprises information required for an initial access; SIB1 is periodically broadcast.

In one embodiment, in a network that supports at least a former of the old version and the 3GPP release version supported by the first node, system information other than MIB and SIB1 can be broadcast, or broadcast in an on-demand way, and the on-demand way means that it is transmitted when there is a request from UE.

In one embodiment, the meaning of the phrase of the first signal being used for an RRC connection is: the first signal is used to request an establishment of an RRC connection or to request a resume of an RRC connection; the first signal comprises an RRC message; a stopping condition of the first timer comprises: receiving a response to the first signal; the meaning of the phrase of accompanying the first signal, starting the first timer comprises: when the first signal is transmitted, the first counter is started.

In one subembodiment of the above embodiment, the first signal is RRCSetupRequest, RRCResumeRequest, and RRCResumeRequest1.

In one subembodiment of the embodiment, a name of an RRC message comprised in the first signal comprises request.

In one subembodiment of the embodiment, the response to the first signal comprises an RRCSetup message.

In one subembodiment of the embodiment, the response to the first signal comprises an RRCResume message.

In one embodiment, when the broadcast information of the first cell does not comprise legacy SIB1, a start of the first timer is later than, and when the broadcast information of the first cell does not comprise legacy SIB1, a start of the first timer.

In one embodiment, SIB1 other than the legacy SIB1 is SIB1 comprising an illegal RRC signaling field.

In one embodiment, SIB1 other than the legacy SIB1 is SIB1 other than old version SIB1.

In one embodiment, SIB1 other than the legacy SIB1 is a new version SIB1.

In one embodiment, the meaning of the phrase of the RRC connection being related to a first cell comprises: the RRC connection is for the first cell.

In one embodiment, the meaning of the phrase of the RRC connection being related to a first cell comprises: the RRC connection is for a cell group to which the first cell belongs or determined by the first cell.

In one embodiment, the meaning of the phrase of the RRC connection being related to a first cell comprises: the RRC connection is an RRC connection between the first node and the first cell.

In one embodiment, the meaning of the phrase of the RRC connection being related to a first cell comprises: the RRC connection is an RRC connection between the first node and an access network to which the first cell belongs.

In one embodiment, the meaning of the phrase of the RRC connection being related to a first cell comprises: the RRC connection is managed or maintained by the first cell.

In one embodiment, the meaning of the phrase of the RRC connection being related to a first cell comprises: contextual information associated with the RRC connection comprises an identity of the first cell.

In one embodiment, the first cell is either in the first state or in the second state.

In one embodiment, the first state and the second state are two of all candidate states of the first cell.

In one embodiment, when the first cell is not waken up, it is in the second state.

In one embodiment, after being waken up, the first cell is in the first state.

In one embodiment, broadcast information of the first cell explicitly indicates whether the first cell is in the first state or the second state.

In one embodiment, broadcast information of the first cell explicitly indicates whether the first cell is in the second state.

In one embodiment, broadcast information of the first cell does not explicitly indicate whether the first cell is in the second state.

In one embodiment, broadcast information of the first cell does not explicitly indicate whether the first cell is in the second state.

In one embodiment, when the first cell is in the first state, legacy UE can access the first cell.

In one embodiment, when the first cell is in the second state, legacy UE cannot access the first cell.

In one embodiment, when the first cell is in the second state, legacy UE can also access the first cell.

In one subembodiment of the embodiment, legacy UE can access the first cell only at specific time.

In one embodiment, cells of 3GPP release 17 and previous versions are always in the first state.

In one embodiment, broadcast information transmitted by cells of 3GPP Release 17 and previous versions are more.

In one embodiment, the meaning of the phrase that broadcast information transmitted by the first cell in the first state is more than broadcast information transmitted in the second state comprises: data volume of broadcast information transmitted by the first cell in the first state is more.

In one embodiment, the meaning of the phrase that broadcast information transmitted by the first cell in the first state is more than broadcast information transmitted in the second state comprises: frequency of broadcast information transmitted by the first cell in the first state is higher.

In one embodiment, the meaning of the phrase that broadcast information transmitted by the first cell in the first state is more than broadcast information transmitted in the second state comprises: types of broadcast information transmitted by the first cell in the first state are more.

In one embodiment, the meaning of the phrase that broadcast information transmitted by the first cell in the first state is more than broadcast information transmitted in the second state comprises: coverage ranges of broadcast information transmitted by the first cell in the first state are larger.

In one embodiment, the meaning of the phrase that broadcast information transmitted by the first cell in the first state is more than broadcast information transmitted in the second state comprises: resources occupied by broadcast information transmitted by the first cell in the first state are more.

In one embodiment, the meaning of the phrase that broadcast information transmitted by the first cell in the first state is more than broadcast information transmitted in the second state comprises: broadcast information of broadcast information transmitted by the first cell in the first state is more intensive.

In one embodiment, the meaning of the phrase that broadcast information transmitted by the first cell in the first state is more than broadcast information transmitted in the second state comprises: broadcast information transmitted by the first cell in the second state is sparser.

In one embodiment, the meaning of the phrase that broadcast information transmitted by the first cell in the first state is more than broadcast information transmitted in the second state comprises: transmission methods of broadcast information transmitted by the first cell in the first state are more.

In one embodiment, the meaning of the phrase that broadcast information transmitted by the first cell in the first state is more than broadcast information transmitted in the second state comprises: CORESETs supported by broadcast information transmitted by the first cell in the first state are more, and CORESET#0 is supported.

In one embodiment, the meaning of the phrase that broadcast information transmitted by the first cell in the first state is more than broadcast information transmitted in the second state comprises: CORESETs of broadcast information transmitted by the first cell in the second state are fewer, and CORESET #0 is not supported.

In one embodiment, the first cell may also have a self-state between the first state and the second state.

In one embodiment, after entering the second state, the first cell automatically returns to the first state after the first time.

In one embodiment, the first node considers: after entering the second state, the first cell automatically returns to the first state after a first time.

In one embodiment, the meaning of the phrase of compared to the first cell in first state, when the first cell is in second state, a start of the first timer being later comprises: assuming that the first timer will expire, compared to the first cell being in a first state, when the first cell is in a second state, an expiration time of the first timer is later.

In one embodiment, the meaning of the phrase of compared to the first cell in first state, when the first cell is in second state, a start of the first timer being later comprises: when the first cell is in a second state refers to when the first signal is transmitted, the first cell is in the second state.

In one embodiment, the meaning of the phrase of compared to the first cell in first state, when the first cell is in second state, a start of the first timer being later comprises: when the first cell is in a second state refers to when the RRC connection process is initiated, the first cell is in the second state.

In one embodiment, the meaning of the phrase of compared to the first cell in first state, when the first cell is in second state, a start of the first timer being later comprises: when the first cell is in a second state refers to when an RRC signaling procedure to which the first signal belongs is started, the first cell is in the second state.

In one embodiment, the meaning of the phrase of compared to the first cell in first state, when the first cell is in second state, a start of the first timer being later comprises: when the first cell is in the second state refers to when the first timer is ready to start, the first cell is in the second state.

In one embodiment, the meaning of the phrase of compared to the first cell in first state, when the first cell is in second state, a start of the first timer being later comprises: when the first cell is in a second state refers to when the first signal is prepared to be transmitted or when the first cell is selected, the first cell is in the second state.

In one embodiment, the first cell being in the second state means that the first cell is not waken up.

In one embodiment, the meaning of the phrase of the first signal being used for an RRC connection is: the first signal is used to request an establishment of an RRC connection or to request a resume of an RRC connection.

In one embodiment, the first signal comprises an RRC message.

In one embodiment, a stopping condition of the first timer comprises: receiving a response to the first signal.

In one embodiment, the meaning of the phrase of accompanying the first signal, starting the first timer comprises: when the first cell is in the first state and when the first signal is transmitted, the first timer is started; when the first cell is in the second state and when the first signal is transmitted and the first cell is waken up, the first timer is started.

In one embodiment, the first timer starts after the first cell is waken up.

In one embodiment, the meaning of the phrase of accompanying the first signal, starting the first timer comprises: when the first cell is in the first state and when the first signal is transmitted, the first timer is started; when the first cell is in the second state and when the first signal is transmitted and broadcast information of the first cell comprises the first-type signal, the first timer is started.

In one subembodiment of the above embodiment, when the first node receives the first-type signal broadcast by the first cell, the first timer is started.

In one subembodiment of the above embodiment, the first-type signal comprises SIB1.

In one subembodiment of the above embodiment, the first-type signal comprises a field of SIB1 prior to 3GPP release 18.

In one subembodiment of the above embodiment, when the first cell is in the first state, broadcast information of the first cell comprises the first-type signal.

### Embodiment 2

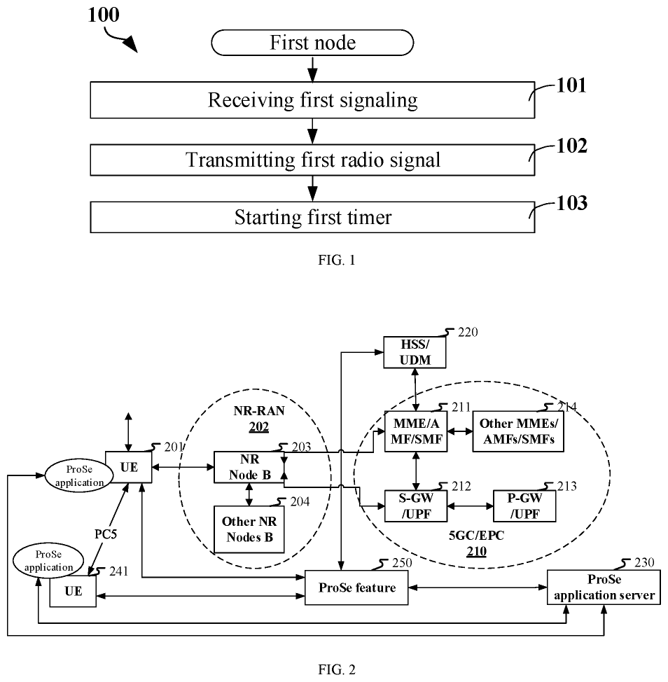

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the first node in the present application is a UE 201.

In one embodiment, a base station of the second node in the present application is a gNB 203.

In one embodiment, a radio link from the UE 201 to NR node B is uplink.

In one embodiment, a radio link from NR node B to UE 201 is downlink.

In one embodiment, the UE 201 supports relay transmission.

In one embodiment, the UE 201 comprises a mobile phone.

In one embodiment, the UE 201 is a vehicle comprising a car.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a flight platform.

In one embodiment, the gNB 203 is satellite equipment.

### Embodiment 3

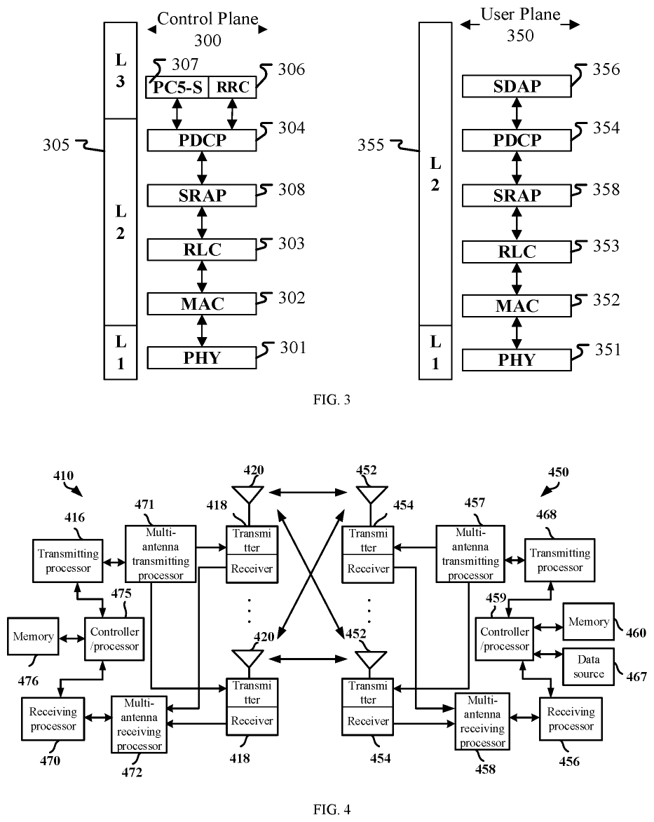

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE, gNB or a satellite or an aircraft in NTN) and a second node (gNB, UE or a satellite or an aircraft in NTN), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first node and a second node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3(L3) of the control plane 300 is responsible for acquiring radio resources (i.e., radio bearer) and configuring the lower layer with an RRC signaling between a second node and a first node. PC5 Signaling Protocol (PC5-S) sublayer 307 is responsible for the processing of signaling protocol at PC5 interface. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. SRB can be seen as a service or interface provided by the PDCP layer to a higher layer, such as the RRC layer. In NR system, SRB comprises SRB1, SRB2, SRB3, and when it comes to sidelink communications, there is also SRB4, which is respectively used to transmit different types of control signalings. SRB, a bearer between a UE and access network, is used to transmit a control signaling, comprising an RRC signaling, between UE and access network. SRB1 has special significance for a UE. After each UE establishes an RRC connection, there will be SRB1 used to transmit RRC signaling. Most of the signalings are transmitted through SRB1. If SRB1 is interrupted or unavailable, the UE must perform RRC reconstruction. SRB2 is generally used only to transmit an NAS signaling or signaling related to security aspects. UE cannot configure SRB3. Except for emergency services, a UE must establish an RRC connection with the network for subsequent communications. Although not described in the figure, the first node may comprise several higher layers above the L2 305. also comprises a network layer (i.e., IP layer) terminated at a P-GW 213 of the network side and an application layer terminated at the other side of the connection (i.e., a peer UE, a server, etc.). For UE involving relay service, its control plane can also comprise the adaptation sub-layer Sidelink Relay Adaptation Protocol (SRAP) 308, and its user plane can also comprise the adaptation sub-layer SRAP358, the introduction of the adaptation layer helps lower layers, such as MAC layer, RLC layer, to multiplex and/or distinguish data from multiple source UEs. For nodes that do not involve relay communications, PC5-S307, SRAP308 and SRAP358 are not required in the communication process.

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC 306.

In one embodiment, the first signal in the present application is generated by the RRC 306 or the MAC 302 or the PHY 301.

In one embodiment, the first message in the present application is generated by the RRC 306.

In one embodiment, the second signal in the present application is generated by the PHY 301.

In one embodiment, the first random access signal in the present application is generated by the PHY 301.

In one embodiment, the third signal in the present application is generated by the RRC 306 or the MAC 302 or the PHY 301.

### Embodiment 4

Embodiment 4 illustrates a schematic diagram of a first communication device and a second communication device according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, optionally may also comprise a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, optional can also comprise a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first signaling, the first signaling is used to configure a value of a first timer; transmits a first signal; accompanying the first signal, starts the first timer; herein, the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state.

In one embodiment, the first communication device 450 comprises at least one processor and at least one memory. a memory that stores a computer readable instruction program. The computer readable instruction program generates an action when executed by at least one processor. The action includes: receiving a first signaling, the first signaling being used to configure a value of a first timer; transmitting a first signal; accompanying the first signal, starting the first timer; herein, the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state.

In one embodiment, the second communication device 410 comprises at least one processor and at least one memory. The at least one memory comprises computer program codes; the at least one memory and the computer program codes are configured to be used in collaboration with the at least one processor, the second communication device 410 at least: transmits a first signaling, the first signaling is used to configure a value of a first timer; receives a first signal; herein, the first timer is started accompanying the first signal; the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state.

In one embodiment, the second communication device 410 comprises a memory that stores a computer readable instruction program. The computer readable instruction program generates an action when executed by at least one processor. The action includes: transmitting a first signaling, the first signaling being used to configure a value of a first timer; receiving a first signal; herein, the first timer is started accompanying the first signal; the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a vehicle terminal.

In one embodiment, the second communication device 450 is a relay.

In one embodiment, the second communication device 410 is a satellite.

In one embodiment, the second communication device 410 is an aircraft.

In one embodiment, the second communication device 410 is a base station.

In one embodiment, the receiver 454 (comprising the antenna 452), the receiving processor 456 and the controller/processor 459 are used to receive the first signaling in the present application.

In one embodiment, the receiver 454 (comprising the antenna 452), the receiving processor 456 and the controller/processor 459 are used to receive the first message in the present application.

In one embodiment, the transmitter 454 (comprising antenna 452), the transmitting processor 468 and the controller/processor 459 are used to transmit the first signal in the present application.

In one embodiment, the transmitter 454 (comprising antenna 452), the transmitting processor 468 and the controller/processor 459 are used to transmit the second signal in the present application.

In one embodiment, the transmitter 454 (comprising antenna 452), the transmitting processor 468 and the controller/processor 459 are used to transmit the third signal in the present application.

In one embodiment, the transmitter 454 (comprising antenna 452), the transmitting processor 468 and the controller/processor 459 are used to transmit the first random access signal in the present application.

In one embodiment, the transmitter 416 (comprising the antenna 420), the transmitting processor 412 and the controller/processor 440 are used to transmit the first signaling in the present application.

In one embodiment, the transmitter 416 (comprising the antenna 420), the transmitting processor 412 and the controller/processor 440 are used to transmit the first message in the present application.

In one embodiment, the receiver 416 (comprising the antenna 420), the receiving processor 412 and the controller/processor 440 are used to receive the first signal in the present application.

In one embodiment, the receiver 416 (comprising the antenna 420), the receiving processor 412 and the controller/processor 440 are used to receive the second signal in the present application.

In one embodiment, the receiver 416 (comprising the antenna 420), the receiving processor 412 and the controller/processor 440 are used to receive the third signal in the present application.

In one embodiment, the receiver 416 (comprising the antenna 420), the receiving processor 412 and the controller/processor 440 are used to receive the first random access signal in the present application.

### Embodiment 5

Embodiment 5 illustrates a flowchart of radio signal transmission according to one embodiment in the present application, as shown in FIG. 5. In FIG. 5, U01 corresponds to a first node in the present application, U02 corresponds to a second node in the present application. It is particularly underlined that the order illustrated in the embodiment does not put constraints over sequences of signal transmissions and implementations and steps in F51 and F52 are optional.

The first node U01 receives a first signaling in step S5101; receives a first message in step S5103; transmits a second signal in step S5104; transmits a first random access signal in step S5105; transmits a first signal in step S5106; transmits a third signal in step S5107.

The second node U02 transmits a first signaling in step S5201; transmits a first message in step S5203. receives a second signal in step S5204; receives a first random access signal in step S5205; receives a first signal in step S5206; receives a third signal in step S5207.

In embodiment 5, the first signaling is used to configure a value of a first timer; the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state.

In one embodiment, accompany the first signal, the first node U01 starts the first timer.

In one embodiment, the first node U01 is a UE that supports versions after 3GPP release 17.

In one embodiment, the second node U02 is a base station.

In one embodiment, the second node U02 is a serving cell of the first node.

In one embodiment, the second node U02 is the first cell.

In one embodiment, the second node U02 is a source cell of the first node.

In one embodiment, the second node U02 is a destination cell of the first node.

In one embodiment, the second node U02 is a primary cell of the first node.

In one embodiment, the second node U02 is a primary cell group of the first node.

In one embodiment, although in FIG. 5, the first signaling is transmitted by the second node U02, and this does not exclude that the first signaling can be transmitted by a node other than the second node U02.

In one embodiment, a transmitter of the first signaling is network.

In one subembodiment of the embodiment, the second node U02 belongs to the network.

In one subembodiment of the embodiment, the first cell belongs to the network.

In one embodiment, a transmitter for the first signaling is the same as a receiver of the first signal.

In one embodiment, a transmitter of the first signaling and a receiver of the first signal may also be different.

In one subembodiment of the embodiment, the method proposed in the present application also supports that a transmitter of the first signal and the receiver of the first signal may also be different.

In one embodiment, after receiving the first signaling, the first node U01 leaves RRC connected state and transmits the first signal in RRC_IDLE state or in RRC_INACTIVE state.

In one subembodiment of the embodiment, the first signaling is RRCReconfiguration.

In one subembodiment of the embodiment, the first signaling is RRCRelease.

In one subembodiment of the embodiment, the first signal is used to establish an RRC connection or used to recover an RRC connection.

In one subembodiment of the embodiment, the second node U02 may be or may not be the first cell.

In one subembodiment of the embodiment, the first cell is a cell selected by the first node U01.

In one embodiment, the first node U01 is always in RRC connected state.

In one subembodiment of the above embodiment, the first signal is used for re-establishing an RRC connection.

In one subembodiment of the above embodiment, the first signal is used for modifying an RRC connection.

In one subembodiment of the above embodiment, the first signal is used for cell handover or cell exchange.

In one subembodiment of the embodiment, the first cell is a cell selected by the first node.

In one subembodiment of the embodiment, the first cell is a destination cell.

In one embodiment, when the first signal is received and the first signal is transmitted, the first node is in an RRC state other than RRC_CONNECTED state.

In one subembodiment of the embodiment, the first signaling comprises an SIB.

In one subembodiment of the embodiment, the first signaling comprises SIB1.

In one subembodiment of the embodiment, the second node U02 is the first cell.

In one embodiment, the first signaling is transmitted to the first node U01 through a dedicated manner.

In one embodiment, the first signaling comprises at least partial fields in an RRCReconfiguration message.

In one embodiment, the first node U01 enters RRC_IDLE state or RRC_INACTIVE state after step S5101 but before step S5106.

In one subembodiment of the embodiment, the first signal is used to request establishing an RRC connection or request resuming an RRC connection.

In one subembodiment of the embodiment, the method proposed in the present application is applicable, as described in FIG. 5, to the first signal being for the second node U02, and also to the first signal being for a cell other than the second node U02.

In one embodiment, the method proposed in the present application is applicable to a transmitter of the first message being the second node U02, and also applicable to a transmitter of the first message being a node other than the second node U02.

In one embodiment, if the first message indicates switching to the second node U02, then a transmitter of the first message is a node other than the second node U02.

In one embodiment, the first message indicates switching to a node other than the second node U02, and a transmitter of the first message can be the second node U02.

In one embodiment, the first message comprises a reconfigurationWithSync field.

In one embodiment, the first message is used to indicate switching.

In one embodiment, the first message is used to configure SpCell.

In one subembodiment of the embodiment, the first message comprises SpCellConfig.

In one embodiment, when the first message is received, the first signal is used to modify an RRC connection.

In one embodiment, when the first message is received, the first timer is started.

In one embodiment, when the first message is executed, the first timer is started.

In one embodiment, when the first message is executed, the first timer is T304.

In one embodiment, only when the first message is received, the first timer is T304, and the first timer is started before the first signal is transmitted.

In one embodiment, step S5203 is transmitted after step S5201.

In one embodiment, when the first signal is used to establish or resume an RRC connection, the first message is not used.

In one embodiment of the above embodiment, the first timer is triggered when the first signal is transmitted.

In one subembodiment of the embodiment, the first timer is a timer other than T304.

In one subembodiment of the embodiment, the first timer is one of T300, T301, T311 and T319.

In one embodiment, establishing an RRC connection comprises re-establishing an RRC connection.

In one embodiment, the first message comprises a conditional reconfiguration of RRC.

In one embodiment, the first node U01 stores the first message after receiving the first message.

In one subembodiment of the embodiment, the first message is used to store a status variable.

In one embodiment, as a response to a condition associated with a conditional reconfiguration of the RRC comprised in the first message being satisfied, the first node U01 executes storing the first message.

In one subembodiment of the embodiment, a conditional reconfiguration of the RRC comprised in the first message comprises or is associated with a triggering condition, and when the triggering condition is met, the conditional reconfiguration of the RRC comprised in the first message is executed.

In one subembodiment of the embodiment, a conditional reconfiguration of the RRC comprised in the first message is used for switching to the first cell.

In one subembodiment of the embodiment, the triggering condition comprises that a measurement result for channel quality meets a first threshold, and the first threshold is configured by the first message.

In one subembodiment of the embodiment, the triggering condition comprises that a measurement result for the first cell meets a first threshold, and the first threshold is configured by the first message.

In one embodiment, the meaning of the phrase of the first signal being used for an RRC connection is: the first signal is used to modify an RRC connection, and the first signal is used to indicate that a reconfiguration of RRC is completed.

In one subembodiment of the embodiment, the first signal comprises at least partial fields in RRCReconfiguration.

In one embodiment, a stopping condition of the first timer comprises: a random access process for the first cell is successfully completed.

In one subembodiment of the embodiment, the meaning of the phrase of a random access for the first cell being successfully completed is, the first cell is successfully accessed.

In one subembodiment of the embodiment, the meaning of the phrase of a random access for the first cell being successfully completed is, a confirmation for random access of the first cell is received.

In one embodiment, the meaning of the phrase of accompanying the first signal, starting the first timer comprises: when the first cell is in the first state and when the stored first message is applied, the first timer is started; when the first cell is in the second state and when the stored first message is applied and the first cell is waken up, the first timer is started; a successful application of the first message triggers a transmission of the first signal.

In one subembodiment of the above embodiment, the first message is used for conditional switching.

In one subembodiment of the above embodiment, the first signal is used to indicate a switching completion.

In one subembodiment of the above embodiment, the first signal comprises an RRCReconfigurationComplete.

In one subembodiment of the above embodiment, when the first message is executed or applied, the first timer is started.

In one subembodiment of the above embodiment, when the first cell is in the second state and when the stored first message is applied and the first cell is not waken up, the first cell needs to be awakened first before starting the first timer.

In one embodiment, the second signal is used to wake up the first cell.

In one embodiment, step S5104 is executed after step S5103.

In one embodiment, step S5104 is executed before step S5105.

In one embodiment, the meaning of the phrase of awakening the first cell comprises: being used to trigger the first cell to exit power-saving state.

In one embodiment, the meaning of the phrase of awakening the first cell comprises: being used to trigger the first cell to transit from power-saving state to another state or enter a normal state, or enter a non-power-saving state.

In one embodiment, the meaning of the phrase of awakening the first cell comprises: triggering the first cell to enter the first state.

In one embodiment, the meaning of the phrase of awakening the first cell comprises: being used to trigger the first cell from not supporting legacy UE to supporting legacy UE.

In one embodiment, the meaning of the phrase of awakening the first cell comprises: activating the first cell.

In one embodiment, the meaning of the phrase of awakening the first cell comprises: being used to trigger the first cell to transmit broadcast information in a second period.

In one subembodiment of the above embodiment, before the first cell is waken up, the first cell transmits broadcast information in a first period.

In one embodiment, the meaning of the phrase of awakening the first cell comprises: being used to trigger the first cell to transmit second-type broadcast information.

In one subembodiment of the above embodiment, before the first cell is affected by the environment, the first cell does not transmit the second-type broadcast information, only first-type broadcast information is transmitted.

In one embodiment, the second signal is a PDU generated at the physical layer and does not comprise the MAC layer.

In one embodiment, advantages of the above methods are that signals at the physical layer are more power-saving, and receiving MAC layer PDUs or higher-layer PDUs is more power-intensive.

In one embodiment, the first random access signal is message 1.

In one embodiment, the first random access signal is a signal of physical layer.

In one embodiment, the first random access signal is a signal generated by a preamble sequence.

In one embodiment, the first random access signal is used to access the first cell.

In one embodiment, candidate resources used for transmitting the first random access signal are related to whether the first cell is waken up.

In one embodiment, candidate resources used for transmitting the first random access signal are related to whether the first cell is in the first state or the second state.

In one subembodiment of the above embodiment, when the first cell is in the first state, there are more candidate resources of the first random access signal compared to in the second state.

In one subembodiment of the above embodiment, a number of candidate resources of the first random access signal is related to whether the first cell is in the first state or the second state.

In one embodiment, resources of the first random access signal belong to the candidate resources of the first random access signal.

In one embodiment, the first node U01 selects resources used by the first random access signal from candidate resources of the first random access signal.

In one embodiment, candidate resources of the first random access signal are determined by broadcast information of the first cell.

In one embodiment, a period of candidate resources of the first random access signal in time domain is determined by a period of broadcast information of the first cell.

In one embodiment, candidate resources of the first random access signal are associated with broadcast information of the first cell.

In one embodiment, when broadcast information of the first cell is transmitted more frequently, candidate resources of the first random access signal will also increase accordingly.

In one embodiment, when broadcast information of the first cell stops being transmitted on partial time-domain resources, candidate resources for a random access signal associated with these time-domain resources will also be excluded.

In one embodiment, the system information is broadcast information.

In one embodiment, whether the system information is broadcast is related to the third signal and/or RRC_CONNECTED state of the first node U01.

In one embodiment, the second timer is used to bar a transmission of signals requesting system information.

In one embodiment, the third signal comprises RRCSystemInfoRequest.

In one embodiment, the third signal comprises a list of requested system information.

In one embodiment, the third signal comprises request SIB1

In one embodiment, the second timer is T350.

In one embodiment, the third signal is used to request request-based system information.

In one subembodiment of the embodiment, the request-based system information is system information not scheduled.

In one subembodiment of the embodiment, the request-based system information is system information not periodically transmitted.

In one embodiment, when the first cell is waken up, a value of the second timer is different from a value of the second timer when the first cell is not waken up.

In one embodiment, when the first cell is waken up, a value of the second timer is less than a value of the second timer when the first cell is not waken up.

In one embodiment, the first signaling is used to configure the second timer.

In one embodiment, a start of the second timer is related to whether the first cell is in the first state or the second state.

In one subembodiment of the above embodiment, when the first cell is in the second state, a start of the second timer is later than a start of the second timer when the first cell is in the second state.

In one embodiment, the first message comprises a reconfiguration of RRC.

In one subembodiment of the above embodiment, the first message comprises RRCREconfiguration.

In one subembodiment of the above embodiment, the first message is used for cell handover.

In one embodiment, the meaning of the phrase of the first signal being used for an RRC connection is: the first signal is used to modify an RRC connection, and the first signal is used to indicate that a reconfiguration of RRC is completed.

In one subembodiment of the above embodiment, the first signal comprises an RRCReconfigurationComplete message.

In one embodiment, a stopping condition for the first timer comprises: a random access process for the first cell is successfully completed.

In one subembodiment of the embodiment, the first cell is a target cell for cell handover.

In one embodiment, the meaning of the phrase of accompanying the first signal, starting the first timer comprises: when the first cell is in the first state and when the first message is received, the first timer is started; when the first cell is in the second state and when the first message is received and the first cell is waken up, the first timer is started.

In one subembodiment of the above embodiment, when the first cell is in the second state and when the first message is received and the first cell is not waken up, the first cell needs to be waken up first before starting the first timer.

In one embodiment, a successful application of the first message triggers a transmission of the first signal.

In one embodiment, the second signal is used to wake up the first cell.

In one embodiment, the second signal is a physical-layer signal.

In one embodiment, before the first cell is waken up, the first cell is in the second state.

In one embodiment, after the first cell is not waken up, the first cell can still be in the second state.

In one subembodiment of the above embodiment, after being waken up, the first cell leaves the power-saving state.

In one subembodiment of the above embodiment, after being waken up, the first cell leaves one of the power-saving states.

In one embodiment, the meaning of the phrase of compared to the first cell in first state, when the first cell is in second state, a start of the first timer being later comprises: when the first cell is in the second state, the first timer starts after the first cell is waken up.

In one embodiment, the meaning of the phrase of compared to the first cell in first state, when the first cell is in second state, a start of the first timer being later comprises: when the first cell is in the second state, it is necessary to wake up the first cell first before the first timer can start.

### Embodiment 6

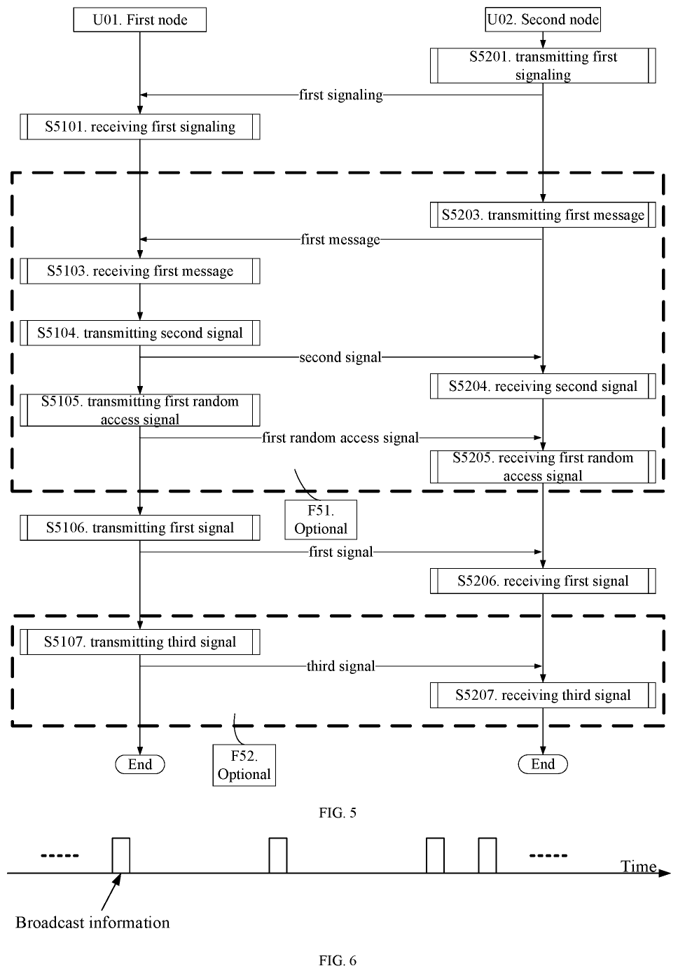

Embodiment 6 illustrates a schematic diagram of broadcast information according to one embodiment of the present application, as shown in FIG. 6.

In one embodiment, broadcast information is generally transmitted periodically, and FIG. 6 only illustrates partial transmissions of broadcast information. In FIG. 6, transmission periods of broadcast information can be different at different times.

In one embodiment, frequency of transmission of broadcast information affects a value of the first timer.

In one embodiment, broadcast information of the first cell can be hierarchical, for example, when the first cell transmits broadcast information more intensively at certain times when in the second state, but an interval between this intensive transmission and the next intensive transmission is longer, that is, transmission of broadcast information becomes, on average, sparser over a longer period of time.

In one subembodiment of the embodiment, this method facilitates ensuring reception quality, and the UE can still merge signals during intensive transmissions.

In one embodiment, FIG. 6 illustrates transmission of broadcast information when the first cell is in the second state and the first state.

In one embodiment, when the first cell is not waken up or not activated, transmission of broadcast information in the first cell is relatively sparse, and when the first cell is waken up or activated, transmission of broadcast information in the first cell is relatively intensive.

In one embodiment, a signal used to wake up the first cell comprises a second signal, and the second signal is different from a signal requesting system information.

In one embodiment, the second signal is not a random access signal.

In one embodiment, the second signal is a wake up signal (WUS) signal.

In one embodiment, when the first node transmits the second signal, as a response, the first cell increases a transmission of broadcast information.

In one embodiment, the first cell transmits broadcast information in a first period within a first time window and transmits broadcast information in a second period within a second time window.

In one embodiment, the first time window is a time when the first cell is not waken up, and the second time window is a time when the first cell is waken up.

In one embodiment, the first time window is the time after the first cell is waken up, and the second time window is a time when the first cell is not waken up.

In one embodiment, during a time when it is not waken up, a transmission period of the broadcast information of the first cell is shorter than a transmission period after being waken up.

In one embodiment, broadcast information of the first cell are transmitted in different states with different intensities and/or periods.

In one embodiment, in the second state, a candidate value for a transmission period of broadcast information of the first cell comprises: 80 ms, 160 ms, 320 ms, 640 ms, 1280 ms.

In one embodiment, in the first state, a candidate value for a transmission period of broadcast information of the first cell comprises: 5 ms, 10 ms, 20 ms, 40 ms.

In one embodiment, in the first state, a candidate value for a transmission period of broadcast information of the first cell comprises: 5 ms, 10 ms, 20 ms, 40 ms.

In one embodiment, after the first state, a transmission period of a synchronization signal in broadcast information of the first cell is 20 ms, and in the second state, a transmission period of a synchronization signal in broadcast information of the first cell is longer than 20 ms.

In one embodiment, after the first state, a transmission period of an MIB in broadcast information of the first cell is 40 ms, and in the second state, a transmission period of an MIB in broadcast information of the first cell is longer than 40 ms.

In one embodiment, in the first state, a transmission period of SIB1 in broadcast information of the first cell is 80 ms, and in the second state, a transmission period of an SIB in broadcast information of the first cell is longer than 80 ms.

In one subembodiment of the embodiment, in the second state, a transmission period of an SIB for broadcast information of the first cell is infinite, that is, only supporting a request-based transmission method.

In one embodiment, whether broadcast information of the first cell is detected in an expected resource pool is used to determine a period of broadcast information of the first cell, or a state in which the first cell is located.

In one subembodiment of the embodiment, when broadcast information of the first cell is not detected within an expected resource pool, it is considered that the first cell is in the second state or a transmission period is a first period.

In one subembodiment of the embodiment, the expected resource pool is fixed.

In one subembodiment of the embodiment, a number of expected resources on which broadcast information of the first cell can be used to determine a transmission period of broadcast information of the first cell, for example, if broadcast information is not detected on half of the expected resources, a transmission period of broadcast information of the first cell is stretched twice as long.

In one embodiment, a ratio of the second period to the first period is used to determine one of the first value and second value.

In one embodiment, the second value is equal to the first value multiplied by a ratio of the second period to the first period.

In one embodiment, the second value is equal to the first value multiplied by a rounding value of a ratio of the second period to the first period.

In one embodiment, the second value is equal to the first value multiplied by a rounding value of a result of a ratio of the second period to the first period.

In one embodiment, a difference value of the second period and the first period as well as the first value are used to determine the second value.

In one embodiment, the second value is equal to a sum of the first value plus a difference value of the second period and the first period.

In one embodiment, the second value is equal to a sum of the first value plus a difference value of the first period and the second period.

In one embodiment, broadcast information of the first cell indicates whether power saving is used, when power saving is used, a period of broadcast information of the first cell is one of a first period or a second period.

In one embodiment, broadcast information of the first cell indicates whether legacy UE is supported, when the legacy UE is not supported, a period of broadcast information of the first cell is one of a first period or a second period.

### Embodiment 7

Embodiment 7 illustrates a schematic diagram of broadcast information according to one embodiment of the present application, as shown in FIG. 7.

In one embodiment, broadcast information is generally transmitted periodically, and FIG. 7 only illustrates partial transmissions of broadcast information, in FIG. 7, content comprised in broadcast information at different times may vary.

In one embodiment, in the second state, broadcast information of the first cell only comprises first-type broadcast information, in the first state, broadcast information of the first cell comprises second-type broadcast information.

In one embodiment, when not awakened, the first cell does not transmit any broadcast information, and after being waken up, the first cell transmits broadcast information.

In one embodiment, when the first cell is in the second state and is waken up, broadcast information transmitted by the first cell is less than broadcast information transmitted in the first state.

In one embodiment, when the first cell is in the second state and is waken up, broadcast information transmitted by the first cell is less than broadcast information transmitted when in the second state but not awakened.

In one embodiment, in the second state, the first cell only transmits request-based broadcast information, and in the first state, the first cell transmits scheduling-based broadcast information.

In one subembodiment of the embodiment, the scheduling-based broadcast information is periodic broadcast information.

In one embodiment, after transmitting the second signal, the first node detects broadcast information of the first cell on a first expected resource pool.

In one embodiment, before transmitting the second signal, the first node detects broadcast information of the first cell on a second expected resource pool.

In one embodiment, resources in the first expected resource pool are more intensive than resources in the second expected resource pool.

In one embodiment, the first-type broadcast information comprises a synchronization signal.

In one embodiment, the first-type broadcast information comprises an SSB.

In one embodiment, the second-type broadcast information comprises SIB1.

In one embodiment, the first-type broadcast information does not comprise SIB1.

In one embodiment, the first-type broadcast information does not comprise paging information.

In one embodiment, the first-type broadcast information comprises paging information.

In one embodiment, when broadcast information of the first cell only comprises first-type broadcast information and does not comprise second-type broadcast information, a value of the first timer is a second value.

In one embodiment, when broadcast information of the first cell comprises second-type broadcast information, a value of the first timer is a first value.

In one embodiment, a downlink signaling other than the legacy RRC signaling is transmitted by the first cell.

In one embodiment, a downlink signaling other than the legacy RRC signaling is transmitted by an anchor cell of the first node.

### Embodiment 8

Embodiment 8 illustrates a schematic diagram of a first signal being used for RRC connection according to one embodiment of the present application, as shown in FIG. 8.

In one embodiment, the first signal is used to request an RRC connection.

In one subembodiment of the embodiment, the first signal comprises RRCSetupRequest.

In one subembodiment of the embodiment, the first signal is used to request establishing an RRC connection.

In one subembodiment of the embodiment, the first signal is used to request re-establishing an RRC connection.

In one subembodiment of the embodiment, a channel occupied by the first signal comprises a common control channel (CCCH).

In one embodiment, the first signal is used to request resuming an RRC connection.

In one subembodiment of the embodiment, the first signal comprises RRCResumeRequest.

In one subembodiment of the embodiment, the first signal comprises RRCResumeRequest1.

In one subembodiment of the embodiment, a channel occupied by the first signal comprises a common control channel (CCCH).

In one embodiment, the first signal is used to confirm an RRC connection.

In one embodiment, the first signal is used to modify an RRC connection.

In one subembodiment of the embodiment, the first signal is used to confirm a completion of modifying an RRC connection.

In one subembodiment of the embodiment, the first signal comprises a MAC CE.

In one subembodiment of the above embodiment, the first signal comprises RRCReconfigurationComplete.

In one subembodiment of the above embodiment, a channel occupied by the first signal comprises a dedicated control channel (DCCH).

In one embodiment, the first signal is for the first cell.

In one embodiment, the first signal occupies resources of the first cell.

### Embodiment 9

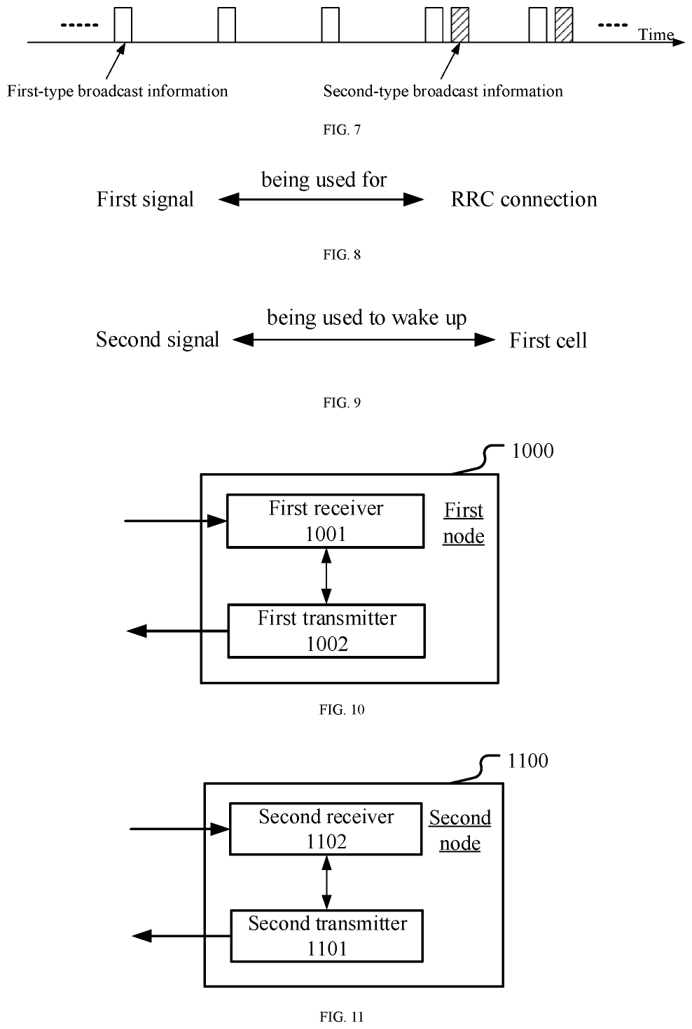

Embodiment 9 illustrates a schematic diagram of the second signal being used to wake up a first cell according to one embodiment of the present application, as shown in FIG. 9.

In one embodiment, broadcast information of the first cell is used to determine whether the first cell is waken up.

In one embodiment, broadcast information of the first cell is used to determine whether the first cell is in the first state or the second state.

In one embodiment, in the first state, the first cell is waken up, and in the second state, the first cell is not waken up.

In one embodiment, in the second state, the first cell can be either awakened or not awakened.

In one subembodiment of the above embodiment, in the first state, the first cell is waken up.

In one subembodiment of the above embodiment, there does not exist wake-up or un-wake-up in the first state of the first cell.

In one embodiment, when the first cell is waken up, the first cell is in the first state; when the first cell is not waken up, the first cell is in the second state.

In one embodiment, when the first cell is waken up, the first cell can be in the second state; when the first cell is not waken up, the first cell is in the second state.

In one embodiment, compared to not being waken up, when the first cell is waken up, the first cell transmits more broadcast information.

In one embodiment, compared to not being waken up, when the first cell is waken up, more types of broadcast information transmitted by the first cell are more.

In one embodiment, compared to not being waken up, when the first cell is waken up, resources occupied by broadcast information transmitted by the first cell are more.

In one embodiment, compared to not being waken up, when the first cell is waken up, UEs supported by broadcast information transmitted by the first cell are more.

In one embodiment, in the first state, legacy UE can access the first cell; even after being waken up in the second state, the legacy UE is still unable to access the first cell.

In one embodiment, SIB1s transmitted by the first cell in the first state are more than SIB1s transmitted in the second state after being waken up.

In one embodiment, SIB1s transmitted by the first cell in the first state are different from SIB1s transmitted in the second state after being waken up.

In one embodiment, SSBs transmitted by the first cell in the first state are more than SSBs transmitted in the second state after being waken up.

### Embodiment 10

Embodiment 10 illustrates a structure block diagram of a processor in a first node according to one embodiment of the present application, as shown in FIG. 10. In FIG. 10, a processor 1000 in a first node comprises a first receiver 1001 and a first transmitter 1002. In Embodiment 10,
the first receiver 1001 receives a first signaling, the first signaling is used to configure a value of a first timer;
the first transmitter 1002 transmits a first signal; accompanying the first signal, starts the first timer;
herein, the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state.

In one embodiment, an expiration of the first timer is used to trigger connection failure.

In one embodiment, the first transmitter 1002 transmits a second signal, and the second signal is used to wake up the first cell;
herein, the second signal is a physical-layer signal; after the first cell is waken up, the first cell enters the first state; the meaning of the phrase of compared to the first cell in first state, when the first cell is in second state, a start of the first timer being later comprises: when the first cell is in the second state, the first timer starts after the first cell is waken up.

In one embodiment, the meaning of the phrase of the first signal being used for an RRC connection is: the first signal is used to request an establishment of an RRC connection or to request a resume of an RRC connection; the first signal comprises an RRC message; a stopping condition of the first timer comprises: receiving a response to the first signal; the meaning of the phrase of accompanying the first signal, starting the first timer comprises: when the first cell is in the first state and when the first signal is transmitted, the first timer is started; when the first cell is in the second state and when the first signal is transmitted and the first cell is waken up, the first timer is started.

In one embodiment, the first receiver 1001 receives a first message; the first message comprises a reconfiguration of RRC;
herein, the meaning of the phrase of the first signal being used for an RRC connection is: the first signal is used to modify an RRC connection, and the first signal is used to indicate that a reconfiguration of RRC is completed; a stopping condition of the first timer comprises: a random access process for the first cell is successfully completed; the meaning of the phrase of accompanying the first signal, starting the first timer comprises: when the first cell is in the first state and when the first message is received, the first timer is started; when the first cell is in the second state and when the first message is received and the first cell is waken up, the first timer is started; a successful application of the first message triggers a transmission of the first signal.

In one embodiment, the first receiver 1001 receives a first message; the first message comprises a conditional reconfiguration of RRC; store the first message; as a response to a condition associated with a conditional reconfiguration of the RRC comprised in the first message being satisfied, executes the stored first message;
herein, the meaning of the phrase of the first signal being used for an RRC connection is: the first signal is used to modify an RRC connection, and the first signal is used to indicate that a reconfiguration of RRC is completed; a stopping condition of the first timer comprises: a random access process for the first cell is successfully completed; the meaning of the phrase of accompanying the first signal, starting the first timer comprises: when the first cell is in the first state and when the stored first message is applied, the first timer is started; when the first cell is in the second state and when the stored first message is applied and the first cell is waken up, the first timer is started; a successful application of the first message triggers a transmission of the first signal.

In one embodiment, the first transmitter 1002 transmits a first random access signal;
herein, candidate resources used for transmitting the first random access signal are related to whether the first cell is in the first state or the second state.

In one embodiment, the first transmitter 1002 transmits a third signal, and the third signal is used to request system information; accompanying a transmission of the third signal, starts a second timer;
herein, the third signal is only transmitted when the second timer is not running; the behavior of starting a second timer comprises setting a value of the second timer, and a start of the second timer is related to whether the first cell is in the first state or the second state.

In one embodiment, the first node is a UE.

In one embodiment, the first node is a terminal that supports NTN.

In one embodiment, the first node is an aircraft or vessel.

In one embodiment, the first node is a mobile phone or vehicle terminal.

In one embodiment, the first node is a relay UE and/or U2N remote UE.

In one embodiment, the first node is an Internet of Things terminal or an Industrial Internet of Things terminal.

In one embodiment, the first node is a device that supports transmission with low-latency and high-reliability.

In one embodiment, the first receiver 1001 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1002 comprises at least one of the antenna 452, the transmitter 454, the transmitting processor 468, the multi-antenna transmitting processor 457, the controller/processor 459, the memory 460 or the data source 467 in Embodiment 4.

### Embodiment 11

Embodiment 11 illustrates a structure block diagram of a processor in a second node according to one embodiment of the present application, as shown in FIG. 11. In FIG. 11, a processor 1100 in a second node comprises a second transmitter 1101 and a second receiver 1102. In Embodiment 11,
the second transmitter 1101 transmits a first signaling, the first signaling is used to configure a value of a first timer;
the second receiver 1102 receives a first signal;
herein, the first timer is started accompanying the first signal; the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state.

In one embodiment, an expiration of the first timer is used to trigger connection failure.

In one embodiment, the second receiver 1102 receives a second signal, and the second signal is used to wake up the first cell;
herein, the second signal is a physical-layer signal; after the first cell is waken up, the first cell enters the first state; the meaning of the phrase of compared to the first cell in first state, when the first cell is in second state, a start of the first timer being later comprises: when the first cell is in the second state, the first timer starts after the first cell is waken up.

In one embodiment, the meaning of the phrase of the first signal being used for an RRC connection is: the first signal is used to request an establishment of an RRC connection or to request a resume of an RRC connection; the first signal comprises an RRC message; a stopping condition of the first timer comprises: receiving a response to the first signal; the meaning of the phrase of accompanying the first signal, starting the first timer comprises: when the first cell is in the first state and when the first signal is transmitted, the first timer is started; when the first cell is in the second state and when the first signal is transmitted and the first cell is waken up, the first timer is started.

In one embodiment, the second transmitter 1101 transmits a first message; the first message comprises a reconfiguration of RRC;
herein, the meaning of the phrase of the first signal being used for an RRC connection is: the first signal is used to modify an RRC connection, and the first signal is used to indicate that a reconfiguration of RRC is completed; a stopping condition of the first timer comprises: a random access process for the first cell is successfully completed; the meaning of the phrase of accompanying the first signal, starting the first timer comprises: when the first cell is in the first state and when the first message is received, the first timer is started; when the first cell is in the second state and when the first message is received and the first cell is waken up, the first timer is started; a successful application of the first message triggers a transmission of the first signal.

In one embodiment, the second transmitter 1101 transmits a first message; the first message comprises a conditional reconfiguration of RRC; stores the first message; as a response to a condition associated with a conditional reconfiguration of the RRC comprised in the first message being satisfied, executes the stored first message;
herein, the meaning of the phrase of the first signal being used for an RRC connection is: the first signal is used to modify an RRC connection, and the first signal is used to indicate that a reconfiguration of RRC is completed; a stopping condition of the first timer comprises: a random access process for the first cell is successfully completed; the meaning of the phrase of accompanying the first signal, starting the first timer comprises: when the first cell is in the first state and when the stored first message is applied, the first timer is started; when the first cell is in the second state and when the stored first message is applied and the first cell is waken up, the first timer is started; a successful application of the first message triggers a transmission of the first signal.

In one embodiment, the second receiver 1102 transmits a first random access signal;
herein, candidate resources used for transmitting the first random access signal are related to whether the first cell is in the first state or the second state.

In one embodiment, the second 1102 receives a third signal, and the third signal is used to request system information; accompanying a transmission of the third signal, start a second timer;
herein, the third signal is only transmitted when the second timer is not running; the behavior of starting a second timer comprises setting a value of the second timer, and a start of the second timer is related to whether the first cell is in the first state or the second state.

In one embodiment, the second node is a satellite.

In one embodiment, the second node is a base station.

In one embodiment, the second node is a relay.

In one embodiment, the second node is an access point.

In one embodiment, the second node is a node supporting multicast.

In one embodiment, the second transmitter 1101 comprises at least one of the antenna 420, the transmitter 418, the transmitting processor 416, the multi-antenna transmitting processor 471, the controller/processor 475 or the memory 476 in Embodiment 4.

In one embodiment, the second receiver 1102 comprises at least one of the antenna 420, the receiver 418, the receiving processor 470, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but not limited to unmanned aerial vehicles, communication modules on unmanned aerial vehicles, tele-controlled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, satellite communication equipment, vessel communication equipment, NTN UEs, etc. The base station or system device in the present application includes but is not limited to macro-cellular base stations, micro-cellular base stations, home base stations, relay base station, gNB (NR node B), Transmitter Receiver Point (TRP), NTN base stations, satellite equipment, flight platform equipment and other radio communication equipment.

This application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling being used to configure a value of a first timer; and
a first transmitter, transmitting a first signal; accompanying the first signal, starting the first timer;
wherein the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state.

2. The first node according to claim 1, wherein
an expiration of the first timer is used to trigger connection failure.

3. The first node according to claim 1, comprising:
the first transmitter, transmitting a second signal, and the second signal being used to wake up the first cell;
wherein the second signal is a physical-layer signal; after the first cell is waken up, the first cell enters the first state; the meaning of the phrase of compared to the first cell in first state, when the first cell is in second state, a start of the first timer being later comprises: when the first cell is in the second state, the first timer starts after the first cell is waken up.

4. The first node according to claim 2, comprising:
the first transmitter, transmitting a second signal, and the second signal being used to wake up the first cell;
wherein the second signal is a physical-layer signal; after the first cell is waken up, the first cell enters the first state; the meaning of the phrase of compared to the first cell in first state, when the first cell is in second state, a start of the first timer being later comprises: when the first cell is in the second state, the first timer starts after the first cell is waken up.

5. The first node according to claim 1, wherein
the meaning of the phrase of the first signal being used for an RRC connection is: the first signal is used to request an establishment of an RRC connection or to request a resume of an RRC connection; the first signal comprises an RRC message; a stopping condition of the first timer comprises: receiving a response to the first signal; the meaning of the phrase of accompanying the first signal, starting the first timer comprises: when the first cell is in the first state and when the first signal is transmitted, the first timer is started; when the first cell is in the second state and when the first signal is transmitted and the first cell is waken up, the first timer is started.

6. The first node according to claim 2, wherein
the meaning of the phrase of the first signal being used for an RRC connection is: the first signal is used to request an establishment of an RRC connection or to request a resume of an RRC connection; the first signal comprises an RRC message; a stopping condition of the first timer comprises: receiving a response to the first signal; the meaning of the phrase of accompanying the first signal, starting the first timer comprises: when the first cell is in the first state and when the first signal is transmitted, the first timer is started; when the first cell is in the second state and when the first signal is transmitted and the first cell is waken up, the first timer is started.

7. The first node according to claim 3, wherein
the meaning of the phrase of the first signal being used for an RRC connection is: the first signal is used to request an establishment of an RRC connection or to request a resume of an RRC connection; the first signal comprises an RRC message; a stopping condition of the first timer comprises: receiving a response to the first signal; the meaning of the phrase of accompanying the first signal, starting the first timer comprises: when the first cell is in the first state and when the first signal is transmitted, the first timer is started; when the first cell is in the second state and when the first signal is transmitted and the first cell is waken up, the first timer is started.

8. The first node according to claim 1, comprising:
the first receiver, receiving a first message; the first message comprising a reconfiguration of RRC;
wherein the meaning of the phrase of the first signal being used for an RRC connection is: the first signal is used to modify an RRC connection, and the first signal is used to indicate that a reconfiguration of RRC is completed; a stopping condition of the first timer comprises: a random access process for the first cell is successfully completed; the meaning of the phrase of accompanying the first signal, starting the first timer comprises: when the first cell is in the first state and when the first message is received, the first timer is started;
when the first cell is in the second state and when the first message is received and the first cell is waken up, the first timer is started; a successful application of the first message triggers a transmission of the first signal.

9. The first node according to claim 2, comprising:
the first receiver, receiving a first message; the first message comprising a reconfiguration of RRC;
wherein the meaning of the phrase of the first signal being used for an RRC connection is: the first signal is used to modify an RRC connection, and the first signal is used to indicate that a reconfiguration of RRC is completed; a stopping condition of the first timer comprises: a random access process for the first cell is successfully completed; the meaning of the phrase of accompanying the first signal, starting the first timer comprises: when the first cell is in the first state and when the first message is received, the first timer is started; when the first cell is in the second state and when the first message is received and the first cell is waken up, the first timer is started; a successful application of the first message triggers a transmission of the first signal.

10. The first node according to claim 3, comprising:
the first receiver, receiving a first message; the first message comprising a reconfiguration of RRC;
wherein the meaning of the phrase of the first signal being used for an RRC connection is: the first signal is used to modify an RRC connection, and the first signal is used to indicate that a reconfiguration of RRC is completed; a stopping condition of the first timer comprises: a random access process for the first cell is successfully completed; the meaning of the phrase of accompanying the first signal, starting the first timer comprises: when the first cell is in the first state and when the first message is received, the first timer is started;
when the first cell is in the second state and when the first message is received and the first cell is waken up, the first timer is started; a successful application of the first message triggers a transmission of the first signal.

11. The first node according to claim 1, comprising:
the first receiver, receiving a first message; the first message comprising a conditional reconfiguration of RRC; storing the first message; as a response to a condition associated with a conditional reconfiguration of the RRC comprised in the first message being satisfied, executing the stored first message;
wherein the meaning of the phrase of the first signal being used for an RRC connection is: the first signal is used to modify an RRC connection, and the first signal is used to indicate that a reconfiguration of RRC is completed; a stopping condition of the first timer comprises: a random access process for the first cell is successfully completed; the meaning of the phrase of accompanying the first signal, starting the first timer comprises: when the first cell is in the first state and when the stored first message is applied, the first timer is started; when the first cell is in the second state and when the stored first message is applied and the first cell is waken up, the first timer is started; a successful application of the first message triggers a transmission of the first signal.

12. The first node according to claim 2, comprising:
the first receiver, receiving a first message; the first message comprising a conditional reconfiguration of RRC; storing the first message; as a response to a condition associated with a conditional reconfiguration of the RRC comprised in the first message being satisfied, executing the stored first message;
wherein the meaning of the phrase of the first signal being used for an RRC connection is: the first signal is used to modify an RRC connection, and the first signal is used to indicate that a reconfiguration of RRC is completed; a stopping condition of the first timer comprises: a random access process for the first cell is successfully completed; the meaning of the phrase of accompanying the first signal, starting the first timer comprises: when the first cell is in the first state and when the stored first message is applied, the first timer is started; when the first cell is in the second state and when the stored first message is applied and the first cell is waken up, the first timer is started; a successful application of the first message triggers a transmission of the first signal.

13. The first node according to claim 3, comprising:
the first receiver, receiving a first message; the first message comprising a conditional reconfiguration of RRC; storing the first message; as a response to a condition associated with a conditional reconfiguration of the RRC comprised in the first message being satisfied, executing the stored first message;
wherein the meaning of the phrase of the first signal being used for an RRC connection is: the first signal is used to modify an RRC connection, and the first signal is used to indicate that a reconfiguration of RRC is completed; a stopping condition of the first timer comprises: a random access process for the first cell is successfully completed; the meaning of the phrase of accompanying the first signal, starting the first timer comprises: when the first cell is in the first state and when the stored first message is applied, the first timer is started; when the first cell is in the second state and when the stored first message is applied and the first cell is waken up, the first timer is started; a successful application of the first message triggers a transmission of the first signal.

14. The first node according to claim 1, comprising:
the first transmitter, transmitting a first random access signal;
wherein candidate resources used for transmitting the first random access signal are related to whether the first cell is in the first state or the second state.

15. The first node according to claim 2, comprising:
the first transmitter, transmitting a first random access signal;
wherein candidate resources used for transmitting the first random access signal are related to whether the first cell is in the first state or the second state.

16. The first node according to claim 1, comprising:
the first transmitter, transmitting a third signal, and the third signal being used to request system information; accompanying a transmission of the third signal, starting a second timer;
wherein the third signal is only transmitted when the second timer is not running; the behavior of starting a second timer comprises setting a value of the second timer, and a start of the second timer is related to whether the first cell is in the first state or the second state.

17. The first node according to claim 2, comprising:
the first transmitter, transmitting a third signal, and the third signal being used to request system information; accompanying a transmission of the third signal, starting a second timer;
wherein the third signal is only transmitted when the second timer is not running; the behavior of starting a second timer comprises setting a value of the second timer, and a start of the second timer is related to whether the first cell is in the first state or the second state.

18. The first node according to claim 3, comprising:
the first transmitter, transmitting a third signal, and the third signal being used to request system information; accompanying a transmission of the third signal, starting a second timer;
wherein the third signal is only transmitted when the second timer is not running; the behavior of starting a second timer comprises setting a value of the second timer, and a start of the second timer is related to whether the first cell is in the first state or the second state.

19. A second node for wireless communications, comprising:
a second transmitter, transmitting a first signaling, the first signaling being used to configure a value of a first timer; and
a second receiver, receiving a first signal;
wherein the first timer is started accompanying the first signal; the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state.

20. A method in a first node for wireless communications, comprising:
receiving a first signaling, the first signaling being used to configure a value of a first timer; and
transmitting a first signal; accompanying the first signal, starting the first timer;
wherein the first signal is used for an RRC connection; the RRC connection is related to a first cell; compared to the first cell being in first state, when the first cell is in second state, a start of the first timer is later; broadcast information transmitted by the first cell in the first state is more than broadcast information transmitted in the second state.
